(19) United States
(12) Patent Application Publication
(10) Pub. No.: US 2026/0091374 A1
(43) Pub. Date: Apr. 2, 2026

(54) NI-BASED CATALYST FOR NH3 REFORMING APPLICATIONS

(71) Applicant: BASF SE, Ludwigshafen am Rhein (DE)

(72) Inventors: Elias Christopher FREI, Ludwigshafen am Rhein (DE); Lukasz KARWACKI, Ludwigshafen am Rhein (DE); Adelheid SCHULZ, Ludwigshafen am Rhein (DE); Nils BOTTKE, Ludwigshafen am Rhein (DE)

(21) Appl. No.: 19/110,118

(22) PCT Filed: Sep. 11, 2023
(86) PCT No.: PCT/EP2023/074908

§ 371 Date: Mar. 10, 2025

(30) Foreign Application Priority Data
Sep. 12, 2022 (EP) 22195128.8

(51) Int. Cl. B01J 23/89; B01J 35/30; B01J 37/02; B01J 37/04; B01J 37/08; B01J 37/18

(52) U.S. Cl. CPC B01J 23/8946; B01J 35/394; B01J 37/0205; B01J 37/04; B01J 37/088; B01J 37/18; C01B 3/047

(57) ABSTRACT

The present invention relates to a catalyst comprising Ni, Ru, and a promoter metal M1, wherein the catalyst displays an Ru:Ni weight ratio in the range of from 0.0001:1 to 0.5:1, wherein the promoter metal M1 is selected from the group consisting of Li, K, Na, Cs, Mg, Ca, Sr, and Ba, including mixtures of two or more thereof, and wherein the catalyst further comprises one or more support materials onto which Ni, Ru, and the promoter metal M1 are respectively supported. Furthermore, the present invention relates to a method for the preparation of a catalyst comprising Ni, Ru, and a promoter metal M1, as well as to a catalyst obtainable according to said method, and to a process for the reforming of ammonia employing the inventive catalyst.

### TECHNICAL FIELD

The present invention relates to a catalyst for the reforming of ammonia as well as to a method for its production and to a process for reforming ammonia in which it is employed.

### INTRODUCTION

NH₃ is seen as an energy vector of the future, able to store chemically significant amounts of H₂. So, sustainable NH₃ might be produced on a large scale from regenerative energy sources. The reforming of NH₃ (see equation 1 below) on site, where the H₂ is needed, might be the last step in closing an H₂ value chain based on renewable electricity.

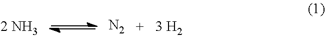

I. Lucentini et al., Ind. Eng. Chem. Res. 2021, 60, 18560-18611 as well as T. Le et al., Korean J. Chem. Eng., 2021, 38(6), 1087-1103 respectively provide an overview of catalysts which are employed in the decomposition of ammonia.

X.-K. Li et al., Journal of Catalysis, 2005, 236, 181-189 specifically relates to the decomposition of ammonia over Ni and Ru catalysts.

Bell et al., Top Catal., 2016, 59,1438-1457 concerns the decomposition of ammonia employing non-noble metal catalysts, wherein mainly Co- and Ni-containing catalysts are discussed.

Despite the large number of catalysts which have been developed for the decomposition of ammonia, there still remains the need for yet more effective catalysts. In particular, there remains the need for catalysts which are capable of converting ammonia to hydrogen and nitrogen at low temperatures, thus allowing for a highly efficient process for the decomposition of ammonia.

### DETAILED DESCRIPTION

Thus, it has surprisingly been found that the use of comparatively low amounts of Ru in a Ni-based catalyst promoted with K affords unexpectedly high conversion rates at low temperatures when employed for the decomposition of ammonia. In particular, a very strong synergy has quite unexpectedly been discovered between Ru, Ni, and K in the catalytic decomposition of ammonia, wherein only small amounts of Ru are required for obtaining a highly efficient catalyst.

Therefore, the present invention relates to a catalyst comprising Ni, Ru, and a promoter metal M1, wherein the catalyst displays an Ru:Ni weight ratio in the range of from 0.0001:1 to 0.5:1, wherein the promoter metal M1 is selected from the group consisting of Li, K, Na, Cs, Mg, Ca, Sr, and Ba, including mixtures of two or more thereof, and wherein the catalyst further comprises one or more support materials onto which Ni, Ru, and the promoter metal M1 are respectively supported.

It is preferred that the catalyst displays an Ru:Ni weight ratio in the range of from 0.001:1 to 0.9:1, more preferably of from 0.005:1 to 0.5:1, more preferably of from 0.01:1 to 0.1:1, more preferably of from 0.02:1 to 0.05:1, and more preferably of from 0.025:1 to 0.035:1.

It is preferred that the promoter metal M1 is selected from the group consisting of Li, K, Na, Cs, Mg, and Ca, including mixtures of two or more thereof, more preferably from the group consisting of Li, K, Na, and Cs, including mixtures of two or more thereof, more preferably from the group consisting of Li, K, and Na, including mixtures of two or more thereof, wherein more preferably the promoter metal M1 is Li, K, or Li and K, wherein more preferably the promoter metal M1 is K, wherein more preferably the promoter metal M1 consists of Li, K, or Li and K, wherein more preferably the promoter metal M1 consists of K.

It is preferred that the catalyst displays an Ni:M1 atomic ratio in the range of from 0.1:1 to 30:1, more preferably of from 0.5:1 to 20:1, more preferably of from 1:1 to 15:1, more preferably of from 1.5:1 to 10:1, more preferably of from 2:1 to 6:1, more preferably of from 2.5:1 to 4:1, more preferably of from 2.7:1 to 3.5:1, and more preferably of from 2.9:1 to 3:1.

It is preferred that the one or more support materials are selected from the group consisting of metal oxides, wherein the metal of the metal oxides is more preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.

It is preferred that from 90 to 100 wt.-% of Ni and Ru calculated as the respective element, and based on 100 wt.-% of Ni and Ru contained in the catalyst, is supported on the one or support materials comprised in the catalyst, more preferably of from 95 to 100 wt.-%, more preferably of from 99 to 100 wt.-%, more preferably of from 99.5 to 100 wt.-%, and more preferably of from 99.9 to 100 wt.-%.

It is preferred that from 90 to 100 wt.-% of Ni, Ru, and the promoter metal M1, calculated as the respective element, and based on 100 wt.-% of Ni, Ru, and the promoter metal M1 contained in the catalyst, is supported on the one or more support materials comprised in the catalyst, more preferably of from 95 to 100 wt.-%, more preferably of from 99 to 100 wt.-%, more preferably of from 99.5 to 100 wt.-%, and more preferably of from 99.9 to 100 wt.-%.

It is preferred that the catalyst comprises Ni in an amount in the range of from 1 to 75 wt.-% calculated as the element and based on 100 wt.-% of the catalyst, more preferably of from 3 to 60 wt.-%, more preferably of from 5 to 40 wt.-%, more preferably of from 10 to 25 wt.-%, more preferably of from 12 to 18 wt.-%, and more preferably of from 14 to 16 wt.-%.

It is preferred that the catalyst comprises Ru in an amount in the range of from 0.01 to 5 wt.-% calculated as the element and based on 100 wt.-% of the catalyst, more preferably of from 0.05 to 2.5 wt.-%, more preferably of from 0.1 to 1.5 wt.-%, more preferably of from 0.2 to 1 wt.-%, more preferably of from 0.3 to 0.8 wt.-%, and more preferably of from 0.4 to 0.6 wt.-%.

It is preferred that the catalyst comprises the promoter metal M1 in an amount in the range of from 0.05 to 25 wt.-% calculated as the element and based on 100 wt.-% of the catalyst, more preferably of from 0.1 to 15 wt.-%, more preferably of from 0.5 to 10 wt.-%, more preferably of from 1 to 8 wt.-%, more preferably of from 2 to 5 wt.-%, and more preferably of from 3 to 4 wt.-%.

It is preferred that from 95 to 100 wt.-% of the catalyst consists of Ni, Ru, the promoter metal M1, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%, wherein Ni, Ru, and the promoter metal M1 may respectively be present as the element, as an oxide, and/or as a salt.

It is preferred that the catalyst comprises the one or more promoter metal M1 as a hydroxide, as a hydrogencarbonate, and/or as a carbonate, more preferably as a hydroxide and/or as a hydrogencarbonate, and more preferably as a hydroxide, wherein more preferably the promoter metal M1 is contained in the catalyst as its hydroxide salt.

It is preferred that Ru is supported on the one or more support materials by an impregnation technique employing an aqueous solution of one or more ruthenium salts, wherein the one or more ruthenium salts more preferably comprise Ru(NO)(NO₃)₃, wherein more preferably Ru(NO)(NO₃)₃ is employed as the one or more ruthenium salts.

It is preferred that the catalyst is in the form of a molding, in the form of extrudates, and/or in powder form, more preferably in the form of a molding or of extrudates, and more preferably in the form of a molding.

In case where the catalyst is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

In case where the catalyst is in the form of a molding, it is preferred that the molding has diameter in the range of 1 to 20 mm, more preferably in the range of 1 to 15 mm.

In case where the catalyst is in the form of a molding, it is preferred that the molding is in the shape of a quadrilobe. Within the meaning of the present patent application, the term quadrilobe preferably refers to a geometry as depicted in FIG. 1 of WO 2020/157202 A1.

The present invention also relates to a method for the preparation of a catalyst comprising Ni, Ru, and a promoter metal M1, preferably of a catalyst comprising Ni, Ru, and a promoter metal M1 according to any one of the particular and preferred embodiments of the present invention, the method comprising
(1) preparing a mixture comprising one or more sources of Ni, one or more support materials and/or one or more precursors thereof, and water;
(2) shaping of the mixture obtained in (1);
(3) calcination of the shaped body obtained in (2);
(4) impregnation of the calcined shaped body obtained in (3) with an aqueous solution of one or more Ru salts;
(5) calcination of the impregnated shaped body obtained in (4);
(6) impregnation of the calcined shaped body obtained in (5) with an aqueous solution of one or more salts of a promoter metal M1, wherein the promoter metal M1 is selected from the group consisting of Li, K, Na, Cs, Mg, Ca, Sr, and Ba, including mixtures of two or more thereof;
(7) calcination of the impregnated shaped body obtained in (6).

It is preferred that in (1) the one or more sources of Ni comprise one or more Ni salts, wherein the anion of the one or more Ni salts are more preferably selected from the group consisting of halides, carbonate, hydrogencarbonate, sulfate, hydrogensulfate, hydroxide, nitrate, phosphate, hydogenphosphate, dihydrogenphosphate, acetate, and combinations of two or more thereof,
more preferably from the group consisting of chloride, bromide, fluoride, hydrogencarbonate, hydrogensulfate, nitrate, dihydrogenphosphate, acetate, and combinations of two or more thereof,
more preferably from the group consisting of chloride, fluoride, nitrate, acetate, and combinations of two or more thereof,
wherein more preferably the anion of the one or more Ni salts is chloride and/or nitrate, preferably nitrate,
and wherein more preferably the one or more sources of Ni comprise nickel(II) nitrate, wherein more preferably the one or more sources of Ni is nickel(II) nitrate.

In case where in (1) the one or more sources of Ni comprise one or more Ni salts, it is preferred that the one or more sources of Ni are provided as an aqueous solution of the one or more nickel salts.

It is preferred that in (1) the one or more support materials are selected from the group consisting of metal oxides, wherein the metal of the metal oxides is more preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.

It is preferred that in (1) the one or more precursors of the one or more support materials comprise hydrotalcite, wherein more preferably the one or more precursors of the one or more support materials is hydrotalcite.

It is preferred that (1) comprises preparing a mixture comprising one or more sources of Ni, one or more precursors of one or more support materials, and water, wherein more preferably (1) consists of preparing a mixture comprising one or more sources of Ni, one or more precursors of one or more support materials, and water.

It is preferred that in (2) shaping is achieved by molding or extrusion of the mixture obtained in (1), more preferably by extrusion.

It is preferred that calcining in (3) is conducted at a temperature in the range of from 500 to 1,150° C., more preferably of from 700 to 1,100° C., more preferably of from 850 to 1,050° C., and more preferably of from 950 to 1,050° C.

It is preferred that calcining in (3) is conducted for a duration in the range of from 0.5 to 9 h, more preferably of from 1.5 to 6 h, and more preferably of from 2 to 3 h.

It is preferred that in (4) the anion of the one or more Ru salts is selected from the group consisting of halides, carbonate, hydrogencarbonate, sulfate, hydrogensulfate, hydroxide, nitrate, phosphate, hydogenphosphate, dihydrogenphosphate, acetate, and combinations of two or more thereof,
more preferably from the group consisting of chloride, bromide, fluoride, hydrogencarbonate, hydrogensulfate, nitrate, dihydrogenphosphate, acetate, and combinations of two or more thereof,
more preferably from the group consisting of chloride, fluoride, nitrate, acetate, and combinations of two or more thereof,
wherein more preferably the anion of the one or more Ru salts is chloride and/or nitrate, preferably nitrate,
and wherein more preferably the one or more Ru salts comprise Ru(NO)(NO₃)₃, wherein more preferably the one or more Ru salts are Ru(NO)(NO₃)₃.

It is preferred that independently from one another, impregnation in (4) and (6) is achieved by incipient wetness.

It is preferred that independently from one another, calcining in (5) and (7) is conducted at a temperature in the range of from 100 to 800° C., more preferably of from 350 to 700° C., more preferably of from 400 to 600° C., and more preferably of from 450 to 550° C.

It is preferred that independently from one another, calcining in (5) and (7) is conducted for a duration in the range of from 1 to 9 h, more preferably of from 1.5 to 6 h, and more preferably of from 2 to 3 h.

It is preferred that in (6) the promoter metal M1 is selected from the group consisting of Li, K, Na, Cs, Mg, and Ca, including mixtures of two or more thereof, preferably from the group consisting of Li, K, Na, and Cs, including mixtures of two or more thereof, more preferably from the group consisting of Li, K, and Na, including mixtures of two or more thereof, wherein more preferably the promoter metal M1 is Li, K, or Li and K, wherein more preferably the promoter metal M1 is K, wherein more preferably the promoter metal M1 consists of Li, K, or Li and K, wherein more preferably the promoter metal M1 consists of K.

It is preferred that in (6) the one or more salts of a promoter metal M1 are selected from the group consisting of hydroxides, hydrogencarbonates, and carbonates, including mixtures of two or more thereof, wherein more preferably the one or more salts of a promoter metal M1 are hydroxides and/or hydrogencarbonates, preferably hydroxides, wherein more preferably the one or more salts of a promoter metal M1 in (6) are hydroxides.

The present invention also relates to a catalyst comprising Ni, Ru, and a promoter metal M1, preferably according to any one of the particular and preferred embodiments of the present invention, as obtained or obtainable according to the method of any one of the particular and preferred embodiments of the inventive method.

The present invention also relates to a process for the reforming of ammonia, wherein the process comprises
(i) providing a reactor containing a catalyst according to any one of the particular and preferred embodiments of the present invention;
(ii) preparing a feed gas stream comprising NH₃;
(iii) feeding the feed gas stream prepared in (ii) into the reactor provided in (i) and contacting the feed gas stream with the catalyst;
(iv) removing an effluent gas stream from the reactor, the effluent gas stream comprising H₂ and N₂.

It is preferred that contacting in (iii) is performed at a pressure in the range of from 1 to 100 bara, more preferably of from 10 to 75 bara, more preferably of from 15 to 40 bara, more preferably of from 18 to 35 bara, more preferably of from 20 to 28 bara, and more preferably of from 20 to 25 bara.

It is preferred that contacting in (iii) is performed at a temperature in the range of from 300 to 1,100° C., more preferably of from 450 to 1,000° C., preferably of from 500 to 900° C., more preferably of from 500 to 800° C., more preferably of from 500 to 600° C.

It is preferred that the feed gas stream prepared in (ii) comprises from 1 to 100 vol.-% of NH₃, more preferably from 3 to 99.99 vol.-%, more preferably from 5 to 99.95 vol.-%, more preferably from 10 to 99.9 vol.-%, more preferably from 20 to 99.8 vol.-%, more preferably from 30 to 99.7 vol.-%, more preferably from 40 to 99.6 vol.-%, and more preferably from 50 to 99.5 vol.-%.

It is preferred that the feed gas stream prepared in (ii) comprises from 0 to 50 vol.-% of N₂, more preferably from 0.01 to 30 vol.-%, more preferably from 0.03 to 15 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.

It is preferred that the feed gas stream prepared in (ii) comprises from 0 to 75 vol.-% of H₂, more preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.

It is preferred that the feed gas stream prepared in (ii) comprises from 100 to 50,000 ppmv of H₂O, more preferably from 200 to 30,000 ppmv, more preferably from 500 to 25,000 ppmv, more preferably from 1,000 to 20,000 ppmv, more preferably from 3,000 to 15,000 ppmv, more preferably from 5,000 to 10,000 ppmv.

It is preferred that the total amount of NH₃, N₂, and H₂ comprised in the feed gas stream prepared in (ii) is in the range from 90 to 100 wt.-%, preferably from 95 to 99.95 vol.-%, more preferably from 98 to 99.9 vol.-%, more preferably from 99 to 99.85 vol.-%, and more preferably from 99.7 to 99.8 vol.-%.

It is preferred that the feed stream is fed into the reactor at a gas hourly space velocity in the range of from 500 to 40,000 h⁻¹, more preferably of from 700 to 20,000 h⁻¹, more preferably of from 800 to 16,000 h⁻¹, more preferably of from 900 to 10,000 h⁻¹, and more preferably of from 1,000 to 8,000 h⁻¹.

It is preferred that after (i) and prior to (iii) the catalyst contained in the reactor provided in (i) is reduced in an atmosphere comprising hydrogen and/or NH₃, more preferably comprising hydrogen.

In case where after (i) and prior to (iii) the catalyst contained in the reactor provided in (i) is reduced in an atmosphere comprising hydrogen and/or NH₃, it is preferred that the reduction is conducted at a temperature in the range of from 450 to 1050° C., more preferably of from 500 to 950° C., more preferably of from 600 to 920° C., more preferably of from 600 to 890° C., more preferably of from 600 to 870° C., and more preferably of from 600 to 700° C.

In case where after (i) and prior to (iii) the catalyst contained in the reactor provided in (i) is reduced in an atmosphere comprising hydrogen and/or NH₃, it is preferred that the reduction is conducted in an atmosphere comprising from 1 to 99 vol.-% H₂, more preferably from 3 to 90 vol.-%, more preferably from 5 to 80 vol.-%, more preferably from 6 to 50 vol.-%, more preferably from 7 to 30 vol.-%, more preferably from 8 to 20 vol.-%, and more preferably from 9 to 15 vol-%. Furthermore and independently thereof, it is preferred that the atmosphere comprises from 1 to 99 vol.-% of an inert gas, more preferably of from 5 to 95 vol.-%, more preferably of from 10 to 90 vol.-%, more preferably from 30 to 70 vol.-%, and more preferably from 45 to 55 vol.-%.

In case where the atmosphere comprises from 1 to 99 vol.-% of an inert gas, it is preferred that the inert gas comprises one or more gases selected from the group consisting of noble gases, CO₂, and nitrogen gas, more preferably from the group consisting of He, Ar, Ne, N₂, and CO₂, wherein more preferably the inert gas comprises CO₂, N₂, or CO₂ and N₂, wherein more preferably the inert gas comprises N₂, wherein more preferably the inert gas is N₂.

According to the present invention, it is preferred that the inventive process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

In case where the inventive process is for the reforming of ammonia and hydrocarbons, it is further preferred that the feed gas stream prepared in (ii) further comprises CO₂ and one or more hydrocarbons, and wherein the feed gas stream more preferably comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O.

In case where the inventive process is for the reforming of ammonia and hydrocarbons, It is alternatively preferred that the feed gas stream prepared in (ii) further comprises H₂O and one or more hydrocarbons, and wherein the feed gas stream preferably comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂.

In case where the inventive process is for the reforming of ammonia and hydrocarbons, it is yet further alternatively preferred that the feed gas stream prepared in (ii) further comprises CO₂, H₂O, and one or more hydrocarbons.

In case where the inventive process is for the reforming of ammonia and hydrocarbons, it is preferred that the one or more hydrocarbons are selected from the group consisting of alkanes and mixtures thereof, more preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof.

Furthermore and independently thereof, it is preferred that contacting is performed at a pressure in the range of from greater than 10 to 50 bara, more preferably of from 12 to 45 bara, more preferably of from 15 to 40 bara, more preferably of from 18 to 35 bara, and more preferably of from 20 to 30 bara.

Furthermore and independently thereof, it is preferred that the feed gas stream prepared in (ii) comprises from 0.1 to 75 vol.-% of NH₃, more preferably from 0.3 to 60 vol.-%, more preferably from 0.5 to 50 vol.-%, more preferably from 0.8 to 40 vol.-%, and more preferably from 1 to 30 vol.-%.

Furthermore and independently thereof, it is preferred that the feed gas stream prepared in (ii) comprises from 10 to 70 vol.-% of the one or more hydrocarbons, more preferably from 12 to 60 vol.-%, and more preferably from 15 to 50 vol.-%.

Furthermore and independently thereof, it is preferred that the feed gas stream prepared in (ii) comprises from 0 to 75 vol.-% of H₂O, more preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, and more preferably from 10 to 60 vol.-%.

Furthermore and independently thereof, it is preferred that the feed gas stream prepared in (ii) comprises from 0 to 60 vol.-% of CO₂, more preferably from 1 to 58 vol.-%, more preferably from 3 to 56 vol.-%, more preferably from 5 to 54 vol.-%, more preferably from 8 to 52 vol.-%, and more preferably from 10 to 50 vol.-%.

Furthermore and independently thereof, it is preferred that the feed stream displays an H₂O:C molar ratio of H₂O to carbon contained in the one or more hydrocarbons in the range of from 0 to 4, more preferably of from 0.1 to 3, more preferably of from 0.3 to 2.5, more preferably of from 0.4 to 2, and more preferably of from 0.5 to 1.6

Furthermore and independently thereof, it is preferred that the feed stream displays a CO₂:C molar ratio of CO₂ to carbon contained in the one or more hydrocarbons in the range of from 0 to 4, more preferably of from 0.1 to 3, more preferably of from 0.2 to 2, and more preferably of from 0.3 to 1.5.

Furthermore and independently thereof, it is preferred that the feed stream displays an NH₃:C molar ratio of NH₃ to carbon contained in the one or more hydrocarbons in the range of from 0 to 5, more preferably of from 0 to 4, more preferably of from 0.001 to 3, more preferably of from 0.005 to 2, and more preferably of from 0.01 to 1.

Furthermore and independently thereof, it is preferred that the feed stream is fed into the reactor at a gas hourly space velocity in the range of from 500 to 16,000 h⁻¹, more preferably of from 700 to 14,000 h⁻¹, more preferably of from 800 to 12,000 h⁻¹, more preferably of from 900 to 10,000 h⁻¹, and more preferably of from 1,000 to 8,000 h⁻¹.

Furthermore and independently thereof, it is preferred that the effluent gas stream removed in (iv) further comprises CO₂.

Furthermore and independently thereof, it is preferred that the effluent gas stream removed in (iv) displays a stoichiometry number R in the range of from 0.1 to 3, wherein R is defined according to formula (1):

$$R = \frac{c ( {H}_{2} ) - c ( {CO}_{2} )}{c ( {CO}_{2} ) + c ( CO )} , \qquad ( I )$$

wherein c(H₂), c(CO₂), and c(CO) stand for the molar concentration of H₂, CO₂, and CO in the effluent gas stream, respectively. It is preferred that the stoichiometry number R is in the range of from 1 to 2.5, more preferably of from 1.3 to 2.2. Alternatively, it is preferred that R>2.

Furthermore and independently thereof it is preferred that the effluent gas stream removed in (iv) displays an H₂:CO molar ratio of >2.

In case where the effluent gas stream removed in (iv) displays an H₂:CO molar ratio of >2, it is preferred that the stoichiometry number R is in the range of 0.5 to 3, more preferably of from 1 to 2.2, and more preferably of 1.3 to 1.7.

In case where the inventive process is for the reforming of ammonia and hydrocarbons, it is preferred that the effluent gas stream removed in (iv) comprises from 10 to 90 vol.-% of H₂, more preferably from 20 to 80 vol.-%, more preferably from 30 to 70 vol.-%, more preferably from 40 to 65 vol.-%, and more preferably from 45 to 60 vol.-%.

Furthermore and independently thereof, it is preferred that the effluent gas stream removed in (iv) comprises from 1 to 70 vol.-% of CO, more preferably from 3 to 50 vol.-%, more preferably from 5 to 40 vol.-%, more preferably from 10 to 35 vol.-%, and more preferably from 15 to 30 vol.-%.

Furthermore and independently thereof, it is preferred that the effluent gas stream removed in (iv) comprises from 1 to 50 vol.-% of CO₂, more preferably from 3 to 45 vol.-%, more preferably from 5 to 40 vol.-%, more preferably from 8 to 35 vol.-%, more preferably from 10 to 30 vol.-%, and more preferably from 12 to 25 vol.-%.

According to the inventive process for the reforming of ammonia, it is preferred that the effluent gas stream removed in (iv) is employed in a process for the production of methanol, for the production of dimethyl ether, or for the production of methanol and dimethylether.

Furthermore, it is preferred that the effluent gas stream removed in (iv) is employed in a process for the production of hydrocarbons, preferably according to the Fischer-Tropsch process.

Furthermore, it is preferred that the effluent gas stream removed in (iv) is employed in a process for the production of alcohols, more preferably of alkanols, more preferably of C1 to C10 alkanols, more preferably of C2 to C8 alkanols, more preferably of C2 to C6 alkanols, more preferably of C2 to C4 alkanols, more preferably of C2 alkanols, and more preferably of ethanol.

Furthermore, it is preferred that at an initial stage of the process, the feed gas stream prepared in (ii) and fed into the reactor in (iii) further comprises H₂ for reducing the catalyst. Preferably, the feed gas stream prepared in (ii) and fed into the reactor in (iii) further comprises from 0.5 to 80 vol.-% of H₂, preferably from 1 to 70 vol.-%, more preferably from 2 to 60 vol.-%, more preferably from 5 to 50 vol.-%, more preferably from 15 to 40 vol.-%.

Finally, the present invention also relates to a use of a catalyst comprising Ni, Ru, and a promoter metal M1 according to any one of the particular and preferred embodiments of the present invention in the reforming of NH₃ to N₂ and H₂.

The present invention is further illustrated by the following set of embodiments and combinations of embodiments resulting from the dependencies and back-references as indicated.

In particular, it is noted that in each instance where a range of embodiments is mentioned, for example in the context of a term such as “The composite oxide of any one of embodiments 1 to 4”, every embodiment in this range is meant to be explicitly disclosed for the skilled person, i.e. the wording of this term is to be understood by the skilled person as being synonymous to “The composite oxide of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A catalyst comprising Ni, Ru, and a promoter metal M1, wherein the catalyst displays an Ru:Ni weight ratio in the range of from 0.0001:1 to 0.5:1, wherein the promoter metal M1 is selected from the group consisting of Li, K, Na, Cs, Mg, Ca, Sr, and Ba, including mixtures of two or more thereof, and wherein the catalyst further comprises one or more support materials onto which Ni, Ru, and the promoter metal M1 are respectively supported.
2. The catalyst of embodiment 1, wherein the catalyst displays an Ru:Ni weight ratio in the range of from 0.001:1 to 0.9:1, preferably of from 0.005:1 to 0.5:1, more preferably of from 0.01:1 to 0.1:1, more preferably of from 0.02:1 to 0.05:1, and more preferably of from 0.025:1 to 0.035:1.
3. The catalyst of embodiment 1 or 2, wherein the promoter metal M1 is selected from the group consisting of Li, K, Na, Cs, Mg, and Ca, including mixtures of two or more thereof, preferably from the group consisting of Li, K, Na, and Cs, including mixtures of two or more thereof, more preferably from the group consisting of Li, K, and Na, including mixtures of two or more thereof, wherein more preferably the promoter metal M1 is Li, K, or Li and K, wherein more preferably the promoter metal M1 is K, wherein more preferably the promoter metal M1 consists of Li, K, or Li and K, wherein more preferably the promoter metal M1 consists of K.
4. The catalyst of any of embodiments 1 to 3, wherein the catalyst displays an Ni:M1 atomic ratio in the range of from 0.1:1 to 30:1, preferably of from 0.5:1 to 20:1, more preferably of from 1:1 to 15:1, more preferably of from 1.5:1 to 10:1, more preferably of from 2:1 to 6:1, more preferably of from 2.5:1 to 4:1, more preferably of from 2.7:1 to 3.5:1, and more preferably of from 2.9:1 to 3:1.
5. The catalyst of any of embodiments 1 to 4, wherein the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.
6. The catalyst of any of embodiments 1 to 5, wherein from 90 to 100 wt.-% of Ni and Ru calculated as the respective element, and based on 100 wt.-% of Ni and Ru contained in the catalyst, is supported on the one or more support materials comprised in the catalyst, preferably of from 95 to 100 wt.-%, more preferably of from 99 to 100 wt.-%, more preferably of from 99.5 to 100 wt.-%, and more preferably of from 99.9 to 100 wt.-%.
7. The catalyst of any of embodiments 1 to 6, wherein from 90 to 100 wt.-% of Ni, Ru, and the promoter metal M1, calculated as the respective element, and based on 100 wt.-% of Ni, Ru, and the promoter metal M1 contained in the catalyst, is supported on the one or more support materials comprised in the catalyst, preferably of from 95 to 100 wt.-%, more preferably of from 99 to 100 wt.-%, more preferably of from 99.5 to 100 wt.-%, and more preferably of from 99.9 to 100 wt.-%.
8. The catalyst of any of embodiments 1 to 7, the catalyst comprises Ni in an amount in the range of from 1 to 75 wt.-% calculated as the element and based on 100 wt.-% of the catalyst, preferably of from 3 to 60 wt.-%, more preferably of from 5 to 40 wt.-%, more preferably of from 10 to 25 wt.-%, more preferably of from 12 to 18 wt.-%, and more preferably of from 14 to 16 wt.-%.
9. The catalyst of any of embodiments 1 to 8, the catalyst comprises Ru in an amount in the range of from 0.01 to 5 wt.-% calculated as the element and based on 100 wt. % of the catalyst, preferably of from 0.05 to 2.5 wt.-%, more preferably of from 0.1 to 1.5 wt.-%, more preferably of from 0.2 to 1 wt.-%, more preferably of from 0.3 to 0.8 wt.-%, and more preferably of from 0.4 to 0.6 wt.-%.
10. The catalyst of any of embodiments 1 to 9, the catalyst comprises the promoter metal M1 in an amount in the range of from 0.05 to 25 wt.-% calculated as the element and based on 100 wt.-% of the catalyst, preferably of from 0.1 to 15 wt.-%, more preferably of from 0.5 to 10 wt.-%, more preferably of from 1 to 8 wt.-%, more preferably of from 2 to 5 wt.-%, and more preferably of from 3 to 4 wt.-%.
11. The catalyst of any of embodiments 1 to 10, from 95 to 100 wt.-% of the catalyst consists of Ni, Ru, the promoter metal M1, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%, wherein Ni, Ru, and the promoter metal M1 may respectively be present as the element, as an oxide, and/or as a salt.
12. The catalyst of any of embodiments 1 to 11, wherein the catalyst comprises the one or more promoter metal M1 as a hydroxide, as a hydrogencarbonate, and/or as a carbonate, preferably as a hydroxide and/or as a hydrogencarbonate, and more preferably as a hydroxide, wherein more preferably the promoter metal M1 is contained in the catalyst as its hydroxide salt.
13. The catalyst of any of embodiments 1 to 12, wherein Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
14. The catalyst of any of embodiments 1 to 13, wherein the catalyst is in the form of a molding, in the form of extrudates, and/or in powder form, preferably in the form of a molding or of extrudates, and more preferably in the form of a molding.
15. The catalyst of embodiment 14, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
16. The catalyst of embodiment 14, wherein the molding has diameter in the range of 1 to 20 mm, preferably in the range of 1 to 15 mm.
17. The catalyst of embodiment 14 or 16, wherein the molding is in the shape of a quadrilobe.
18. A method for the preparation of a catalyst comprising Ni, Ru, and a promoter metal M1, preferably of a catalyst comprising Ni, Ru, and a promoter metal M1 according to any of embodiments 1 to 17, the method comprising
   (1) preparing a mixture comprising one or more sources of Ni, one or more support materials and/or one or more precursors thereof, and water;
   (2) shaping of the mixture obtained in (1);
   (3) calcination of the shaped body obtained in (2);
   (4) impregnation of the calcined shaped body obtained in (3) with an aqueous solution of one or more Ru salts;
   (5) calcination of the impregnated shaped body obtained in (4);
   (6) impregnation of the calcined shaped body obtained in (5) with an aqueous solution of one or more salts of a promoter metal M1, wherein the promoter metal M1 is selected from the group consisting of Li, K, Na, Cs, Mg, Ca, Sr, and Ba, including mixtures of two or more thereof;
   (7) calcination of the impregnated shaped body obtained in (6).
19. The method of embodiment 18, wherein in (1) the one or more sources of Ni comprise one or more Ni salts, wherein the anion of the one or more Ni salts are preferably selected from the group consisting of halides, carbonate, hydrogencarbonate, sulfate, hydrogensulfate, hydroxide, nitrate, phosphate, hydogenphosphate, dihydrogenphosphate, acetate, and combinations of two or more thereof,
   more preferably from the group consisting of chloride, bromide, fluoride, hydrogencarbonate, hydrogensulfate, nitrate, dihydrogenphosphate, acetate, and combinations of two or more thereof, more preferably from the group consisting of chloride, fluoride, nitrate, acetate, and combinations of two or more thereof,
   wherein more preferably the anion of the one or more Ni salts is chloride and/or nitrate, preferably nitrate,
   and wherein more preferably the one or more sources of Ni comprise nickel(II) nitrate, wherein more preferably the one or more sources of Ni is nickel(II) nitrate.
20. The method of embodiment 19, wherein the one or more sources of Ni are provided as an aqueous solution of the one or more nickel salts.
21. The method of any of embodiments 18 to 20, wherein in (1) the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, more preferably from the group consisting of ZrO₂, NiMgO₂, and MgAl₂O₄, including mixtures of two or more thereof, wherein more preferably the one or more support materials comprise MgAl₂O₄, preferably NiMgO₂ and MgAl₂O₄, wherein more preferably the one or more support materials consist of MgAl₂O₄, or of NiMgO₂ and MgAl₂O₄, preferably of NiMgO₂ and MgAl₂O₄.
22. The method of any of embodiments 18 to 21, wherein in (1) the one or more precursors of the one or more support materials comprise hydrotalcite, wherein preferably the one or more precursors of the one or more support materials is hydrotalcite.
23. The method of any of embodiments 18 to 22, wherein (1) comprises preparing a mixture comprising one or more sources of Ni, one or more precursors of one or more support materials, and water, wherein preferably (1) consists of preparing a mixture comprising one or more sources of Ni, one or more precursors of one or more support materials, and water.
24. The method of any of embodiments 18 to 23, wherein in (2) shaping is achieved by molding or extrusion of the mixture obtained in (1), preferably by extrusion.
25. The method of any of embodiments 18 to 24, wherein calcining in (3) is conducted at a temperature in the range of from 500 to 1,150° C., preferably of from 700 to 1,100° C., more preferably of from 850 to 1,050° C., and more preferably of from 950 to 1,050° C.
26. The method of any of embodiments 18 to 25, wherein calcining in (3) is conducted for a duration in the range of from 0.5 to 9 h, preferably of from 1.5 to 6 h, and more preferably of from 2 to 3 h.
27. The method of any of embodiments 18 to 26, wherein in (4) the anion of the one or more Ru salts is selected from the group consisting of halides, carbonate, hydrogencarbonate, sulfate, hydrogensulfate, hydroxide, nitrate, phosphate, hydogenphosphate, dihydrogenphosphate, acetate, and combinations of two or more thereof, more preferably from the group consisting of chloride, bromide, fluoride, hydrogencarbonate, hydrogensulfate, nitrate, dihydrogenphosphate, acetate, and combinations of two or more thereof,
   more preferably from the group consisting of chloride, fluoride, nitrate, acetate, and combinations of two or more thereof,
   wherein more preferably the anion of the one or more Ru salts is chloride and/or nitrate, preferably nitrate,
   and wherein more preferably the one or more Ru salts comprise Ru(NO)(NO₃)₃, wherein more preferably the one or more Ru salts are Ru(NO)(NO₃)₃.
28. The method of any of embodiments 18 to 27, wherein independently from one another, impregnation in (4) and (6) is achieved by incipient wetness.
29. The method of any of embodiments 18 to 28, wherein independently from one another, calcining in (5) and (7) is conducted at a temperature in the range of from 100 to 800° C., preferably of from 350 to 700° C., more preferably of from 400 to 600° C., and more preferably of from 450 to 550° C.
30. The method of any of embodiments 18 to 29, wherein independently from one another, calcining in (5) and (7) is conducted for a duration in the range of from 1 to 9 h, preferably of from 1.5 to 6 h, and more preferably of from 2 to 3 h.
31. The method of any of embodiments 18 to 30, wherein in (6) the promoter metal M1 is selected from the group consisting of Li, K, Na, Cs, Mg, and Ca, including mixtures of two or more thereof, preferably from the group consisting of Li, K, Na, and Cs, including mixtures of two or more thereof, more preferably from the group consisting of Li, K, and Na, including mixtures of two or more thereof, wherein more preferably the promoter metal M1 is Li, K, or Li and K, wherein more preferably the promoter metal M1 is K, wherein more preferably the promoter metal M1 consists of Li, K, or Li and K, wherein more preferably the promoter metal M1 consists of K.
32. The method of any of embodiments 18 to 31, wherein in (6) the one or more salts of a promoter metal M1 are selected from the group consisting of hydroxides, hydrogencarbonates, and carbonates, including mixtures of two or more thereof, wherein preferably the one or more salts of a promoter metal M1 are hydroxides and/or hydrogencarbonates, preferably hydroxides, wherein more preferably the one or more salts of a promoter metal M1 in (6) are hydroxides.
33. A catalyst comprising Ni, Ru, and a promoter metal M1, preferably according to any of embodiments 1 to 17, as obtained or obtainable according to the method of any of embodiments 18 to 32.
34. A process for the reforming of ammonia, wherein the process comprises
   (i) providing a reactor containing a catalyst according to any of embodiments 1 to 17 and 33;
   (ii) preparing a feed gas stream comprising NH₃;
   (iii) feeding the feed gas stream prepared in (ii) into the reactor provided in (i) and contacting the feed gas stream with the catalyst;
   (iv) removing an effluent gas stream from the reactor, the effluent gas stream comprising H₂ and N₂.
35. The process of embodiment 34, wherein contacting in (iii) is performed at a pressure in the range of from 1 to 100 bara, preferably of from 10 to 75 bara, more preferably of from 15 to 40 bara, more preferably of from 18 to 35 bara, more preferably of from 20 to 28 bara, and more preferably of from 20 to 25 bara.
36. The process of embodiment 34 or 35, wherein contacting in (iii) is performed at a temperature in the range of from 300 to 1,100° C., preferably of from 450 to 1,000° C., preferably of from 500 to 900° C., more preferably of from 500 to 800° C., more preferably of from 500 to 600° C.
37. The process of any of embodiments 34 to 36, wherein the feed gas stream prepared in (ii) comprises from 1 to 100 vol.-% of NH₃, preferably from 3 to 99.99 vol.-%, more preferably from 5 to 99.95 vol.-%, more preferably from 10 to 99.9 vol.-%, more preferably from 20 to 99.8 vol.-%, more preferably from 30 to 99.7 vol.-%, more preferably from 40 to 99.6 vol.-%, and more preferably from 50 to 99.5 vol.-%.
38. The process of any of embodiment 34 to 37, wherein the feed gas stream prepared in (ii) comprises from 0 to 50 vol.-% of N₂, preferably from 0.01 to 30 vol.-%, more preferably from 0.03 to 15 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.
39. The process of any of embodiments 34 to 38, wherein the feed gas stream prepared in (ii) comprises from 0 to 75 vol.-% of H₂, preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.
40. The process of any of embodiments 34 to 39, wherein the feed gas stream prepared in (ii) comprises from 100 to 50,000 ppmv of H₂O, preferably from 200 to 30,000 ppmv, more preferably from 500 to 25,000 ppmv, more preferably from 1,000 to 20,000 ppmv, more preferably from 3,000 to 15,000 ppmv, more preferably from 5,000 to 10,000 ppmv.
41. The process of any of embodiments 34 to 40, wherein the total amount of NH₃, N₂, and H₂ comprised in the feed gas stream prepared in (ii) is in the range from 90 to 100 wt.-%, preferably from 95 to 99.95 vol.-%, more preferably from 98 to 99.9 vol.-%, more preferably from 99 to 99.85 vol.-%, and more preferably from 99.7 to 99.8 vol.-%.
42. The process of any of embodiments 34 to 41, wherein the feed stream is fed into the reactor at a gas hourly space velocity in the range of from 500 to 40,000 h⁻¹, preferably of from 700 to 20,000 h⁻¹, more preferably of from 800 to 16,000 h⁻¹, more preferably of from 900 to 10,000 h⁻¹, and more preferably of from 1,000 to 8,000 h⁻¹.
43. The process of any of embodiments 34 to 42, wherein after (i) and prior to (iii) the catalyst contained in the reactor provided in (i) is reduced in an atmosphere comprising hydrogen and/or NH₃, preferably comprising hydrogen.
44. The process of embodiment 43, wherein the reduction is conducted at a temperature in the range of from 450 to 1050° C., preferably of from 500 to 950° C., more preferably of from 600 to 920° C., more preferably of from 600 to 890° C., more preferably of from 600 to 870° C., and more preferably of from 600 to 700° C.
45. The process of embodiment 43 or 44, wherein the reduction is conducted in an atmosphere comprising from 1 to 99 vol.-% H₂, preferably from 3 to 90 vol.-%, more preferably from 5 to 80 vol.-%, more preferably from 6 to 50 vol.-%, more preferably from 7 to 30 vol.-%, more preferably from 8 to 20 vol.-%, and more preferably from 9 to 15 vol-%.
46. The process of any of embodiments 43 to 45, wherein the atmosphere comprises from 1 to 99 vol.-% of an inert gas, preferably of from 5 to 95 vol.-%, more preferably of from 10 to 90 vol.-%, more preferably from 30 to 70 vol.-%, and more preferably from 45 to 55 vol.-%.
47. The process of embodiment 46, wherein the inert gas comprises one or more gases selected from the group consisting of noble gases, CO₂, and nitrogen gas, preferably from the group consisting of He, Ar, Ne, N₂, and CO₂, wherein more preferably the inert gas comprises CO₂, N₂, or CO₂ and N₂, wherein more preferably the inert gas comprises N₂, wherein more preferably the inert gas is N₂.
48. The process of any of embodiments 34 to 47, wherein the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.
49. The process of embodiment 48, wherein the feed gas stream prepared in (ii) further comprises CO₂ and one or more hydrocarbons, and wherein the feed gas stream preferably comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O.
50. The process of embodiment 48, wherein the feed gas stream prepared in (ii) further comprises H₂O and one or more hydrocarbons, and wherein the feed gas stream preferably comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂.
51. The process of embodiment 48, wherein the feed gas stream prepared in (ii) further comprises CO₂, H₂O, and one or more hydrocarbons.
52. The process of any of embodiments 48 to 51, wherein the one or more hydrocarbons are selected from the group consisting of alkanes and mixtures thereof, preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof.
53. The process of any of embodiments 48 to 52, wherein contacting is performed at a pressure in the range of from greater than 10 to 50 bara, preferably of from 12 to 45 bara, more preferably of from 15 to 40 bara, more preferably of from 18 to 35 bara, and more preferably of from 20 to 30 bara.
54. The process of any of embodiments 48 to 53, wherein the feed gas stream prepared in (ii) comprises from 0.1 to 75 vol.-% of NH₃, preferably from 0.3 to 60 vol.-%, more preferably from 0.5 to 50 vol.-%, more preferably from 0.8 to 40 vol.-%, and more preferably from 1 to 30 vol.-%.
55. The process of any of embodiments 48 to 54, wherein the feed gas stream prepared in (ii) comprises from 10 to 70 vol.-% of the one or more hydrocarbons, preferably from 12 to 60 vol.-%, and more preferably from 15 to 50 vol.-%.
56. The process of any of embodiments 48 to 55, wherein the feed gas stream prepared in (ii) comprises from 0 to 75 vol.-% of H₂O, preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, and more preferably from 10 to 60 vol.-%.
57. The process of any of embodiments 48 to 56, wherein the feed gas stream prepared in (ii) comprises from 0 to 60 vol.-% of CO₂, preferably from 1 to 58 vol.-%, more preferably from 3 to 56 vol.-%, more preferably from 5 to 54 vol.-%, more preferably from 8 to 52 vol.-%, and more preferably from 10 to 50 vol.-%.
58. The process of any of embodiments 48 to 57, wherein the feed stream displays an H₂O:C molar ratio of H₂O to carbon contained in the one or more hydrocarbons in the range of from 0 to 4, preferably of from 0.1 to 3, more preferably of from 0.3 to 2.5, more preferably of from 0.4 to 2, and more preferably of from 0.5 to 1.6
59. The process of any of embodiments 48 to 58, wherein the feed stream displays a CO₂:C molar ratio of CO₂ to carbon contained in the one or more hydrocarbons in the range of from 0 to 4, preferably of from 0.1 to 3, more preferably of from 0.2 to 2, and more preferably of from 0.3 to 1.5.
60. The process of any of embodiments 48 to 59, wherein the feed stream displays an NH₃:C molar ratio of NH₃ to carbon contained in the one or more hydrocarbons in the range of from 0 to 5, preferably of from 0 to 4, more preferably of from 0.001 to 3, more preferably of from 0.005 to 2, and more preferably of from 0.01 to 1.
61. The process of any of embodiments 48 to 60, wherein the feed stream is fed into the reactor at a gas hourly space velocity in the range of from 500 to 16,000 h⁻¹, preferably of from 700 to 14,000 h⁻¹, more preferably of from 800 to 12,000 h⁻¹, more preferably of from 900 to 10,000 h⁻¹, and more preferably of from 1,000 to 8,000 h⁻¹.
62. The process of any of embodiments 48 to 61, wherein the effluent gas stream removed in (iv) further comprises CO₂.
63. The process of any of embodiments 48 to 62, wherein the effluent gas stream removed in (iv) displays a stoichiometry number R in the range of from 0.1 to 3, wherein R is defined according to formula (1):

$$R = \frac{c ( {H}_{2} ) - c ( {CO}_{2} )}{c ( {CO}_{2} ) + c ( CO )} , \qquad ( I )$$

wherein c(H₂), c(CO₂), and c(CO) stand for the molar concentration of H₂, CO₂, and CO in the effluent gas stream, respectively.
64. The process of embodiment 63, wherein the stoichiometry number R is in the range of from 1 to 2.5, preferably of from 1.3 to 2.2.
65. The process of embodiment 63, wherein R>2.
66. The process of any of embodiments 48 to 62 and 65, wherein the effluent gas stream removed in (iv) displays an H₂:CO molar ratio of >2.
67. The process of embodiment 63, wherein the stoichiometry number R is in the range of 0.5 to 3, preferably of from 1 to 2.2, and more preferably of 1.3 to 1.7.
68. The process of any of embodiments 48 to 67, wherein the effluent gas stream removed in (iv) comprises from 10 to 90 vol.-% of H₂, preferably from 20 to 80 vol.-%, more preferably from 30 to 70 vol.-%, more preferably from 40 to 65 vol.-%, and more preferably from 45 to 60 vol.-%.
69. The process of any of embodiments 48 to 68, wherein the effluent gas stream removed in (iv) comprises from 1 to 70 vol.-% of CO, preferably from 3 to 50 vol.-%, more preferably from 5 to 40 vol.-%, more preferably from 10 to 35 vol.-%, and more preferably from 15 to 30 vol.-%.
70. The process of any of embodiments 48 to 69, wherein the effluent gas stream removed in (iv) comprises from 1 to 50 vol.-% of CO₂, preferably from 3 to 45 vol.-%, more preferably from 5 to 40 vol.-%, more preferably from 8 to 35 vol.-%, more preferably from 10 to 30 vol.-%, and more preferably from 12 to 25 vol.-%.
71. The process of any of embodiments 34 to 70, wherein the effluent gas stream removed in (iv) is employed in a process for the production of methanol, for the production of dimethyl ether, or for the production of methanol and dimethylether.
72. The process of any of embodiments 34 to 71, wherein the effluent gas stream removed in (iv) is employed in a process for the production of hydrocarbons, preferably according to the Fischer-Tropsch process.
73. The process of any of embodiments 34 to 72, wherein the effluent gas stream removed in (iv) is employed in a process for the production of alcohols, preferably of alkanols, more preferably of C1 to C10 alkanols, more preferably of C2 to C8 alkanols, more preferably of C2 to C6 alkanols, more preferably of C2 to C4 alkanols, more preferably of C2 alkanols, and more preferably of ethanol.
74. The process of any of embodiments 34 to 73, wherein at an initial stage of the process, the feed gas stream prepared in (ii) and fed into the reactor in (iii) further comprises H₂ for reducing the catalyst.
75. The process of embodiment 74, wherein the feed gas stream prepared in (ii) and fed into the reactor in (iii) further comprises from 0.5 to 80 vol.-% of H₂, preferably from 1 to 70 vol.-%, more preferably from 2 to 60 vol.-%, more preferably from 5 to 50 vol.%, more preferably from 15 to 40 vol.-%.
76. Use of a catalyst comprising Ni, Ru, and a promoter metal M1 according to any of embodiments 1 to 17 or 33 in the reforming of NH₃ to N₂ and H₂.

### DESCRIPTION OF THE FIGURES

FIG. 1 displays the results of NH₃ reforming on the extruded catalysts at a GHSV of 4,000 h⁻¹, p(NH₃)=20 bara and co-feeding of 5,000 ppm-vol of H₂O. The extruded catalysts were tested between 30° and 650° C. The results obtained for 15 wt.-% of Ni supported on MgO/Al₂O₃ mixed oxide, without (catalyst of reference example 2) and with (catalysts from reference example 3) 0.1 and 0.5 wt.-% Ru promotion is shown, as well as the results obtained with the latter Ru-promoted catalyst which were additionally promoted with 3.5 wt.-% K according to inventive example 4.

FIG. 2 displays the results of NH₃ reforming on the tableted catalysts at a GHSV of 4,000 h⁻¹, p(NH₃)=30 bara and co-feeding of 5,000 ppm-vol of H₂O. The tableted catalysts were tested between 30° and 650° C. The results obtained for 15 wt.-% of Ni supported on MgO/Al₂O₃ mixed oxide, without (catalyst of reference example 2) and with (catalyst from reference example 3) 0.5 wt.-% Ru promotion is shown, as well as the results obtained with the latter Ru-promoted catalyst which were additionally promoted with 3.5 wt.-% K according to inventive example 4. Furthermore, for comparison, a catalyst with 15 wt. % Ni and 3.5 wt. % KOH without Ru is included (catalyst from comparative example 5).

FIG. 3 displays the XRD pattern of the catalyst of reference example 2, wherein the Mg,Al-spinel structure is clearly identified as constituting part of the support material. In the diffractogram, the line pattern (without an asterix) of MgAl₂O₄ as well as the line pattern of cubic MgNiO₂ (lines with an asterix) have been included.

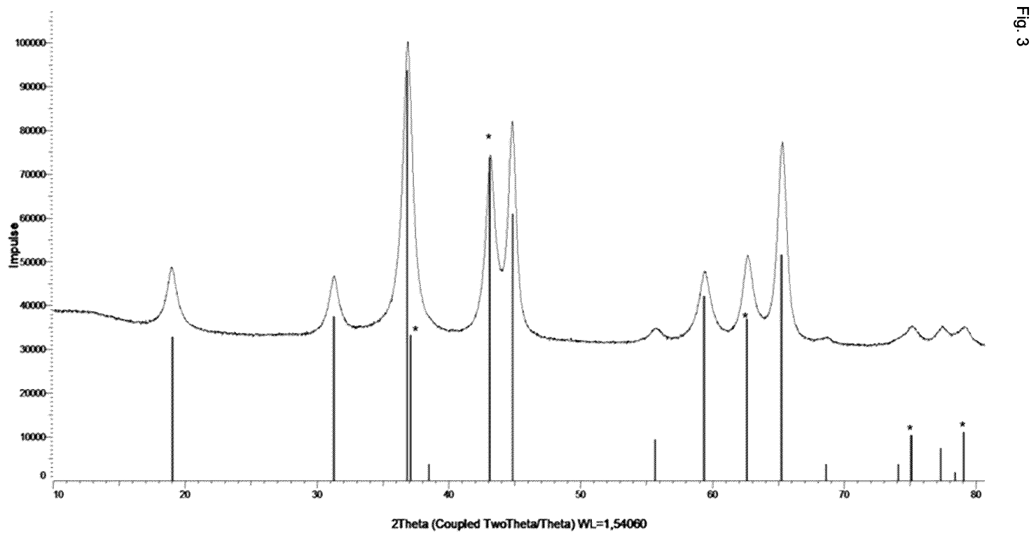

### EXPERIMENTAL SECTION

The present invention is further illustrated by the following examples.

### Reference Example 1: Preparation of a Tableted Ni (15.5 wt.-%) Catalyst Supported on MgO/Al₂O₃ Mixed Oxide

A catalyst comprising Ni was prepared based on the process described as example E1 of WO 2013/068905 A1. As opposed to example E1 of WO 2013/068905 A1, an aqueous solution of nickel nitrate (14 wt.-% Ni concentration) was used instead of the pulverulent nickel nitrate hexahydrate. The various ingredients were mixed to a paste which was extruded. The extrudates were crushed and sieved to a target fraction having a particle size of from 200 to 900 μm after drying and low temperature calcination.

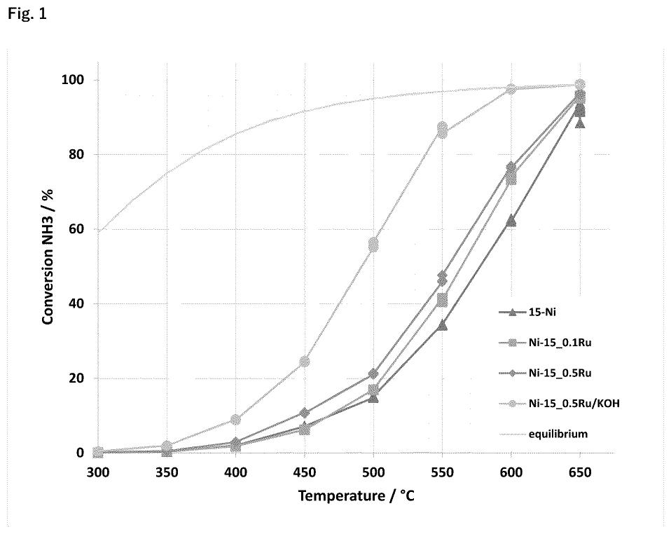

The sieved powder was then mixed with graphite 2.8 weight.-% (Asbury Graphite 3160) and 5.5 weight-% cellulose (Arbocel BWW 40). The resulting mixture was tableted to moldings having a four-hole cross-section as shown in FIG. 1 of WO 2020/157202 A. For calcination, the moldings were heated in an annealing furnace to a temperature of 1,030 to 1,050° C. which was held for 4 hours.

The nickel content of the calcined moldings was 15.5 weight-%, the magnesium content 14.0 weight-%, and the aluminium content was 29.5 weight-%.

### Reference Example 2: Preparation of an Extruded Ni (15.0 wt.-%) Catalyst Supported on MgO/Al₂O₃ Mixed Oxide

As for reference example 1, a catalyst comprising Ni was prepared based on the process described as example E1 of WO 2013/068905 A1. The Ni-salt solution employed in reference example 1 was mixed with the hydrotalcite and suitable amounts of water to prepare an extrudable paste. This paste was extruded in the next step. The subsequent heat treatment of the resulting extrudate was kept between 85° and 1050° C.

The nickel content of the calcined extrudates was 15.0 weight-%, the magnesium content 14.0 weight-%, the aluminium content was 29.5 weight-%.

### Reference Example 3: Promotion of the Ni Catalysts of Examples 1 and 2 with Ru (0.1 and 0.5 wt.-%)

The catalysts prepared in examples 1 and 2 were respectively impregnated based on the water-uptake of the materials with a solution of Ru(NO(NO₃)₃). The Ru loadings were fixed to 0.1 and 0.5 weight-%. Further, the impregnated samples were respectively heat treated up to 500° C.

### Example 4: Promotion of the Ni/Ru Catalysts of Example 3 with K (3.5 wt.-%)

The catalysts prepared in example 3 were respectively impregnated based on the water-uptake of the materials with a KOH-solution. The KOH loading was fixed to 3.5 weight-% of K (5 wt.-% of KOH). Further, the impregnated samples were heat treated up to 500° C.

### Comparative Example 5: Promotion of the Ni Catalyst of Example 1 with K (3.5 wt.-%)

The catalyst prepared in example 1 was impregnated based on the water-uptake of the material with a KOH-solution. The KOH loading was fixed to 3.5 wt. % of K (5 wt.-% of KOH) and the impregnated sample was heated to 500° C.

### Example 6: Catalytic Tests in NH3-Reforming Under High Pressure

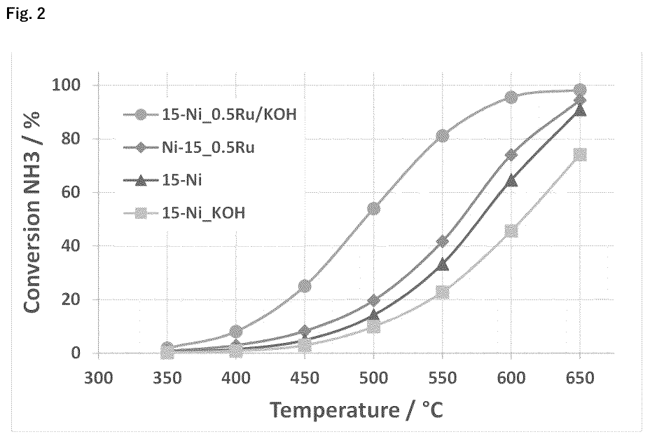

The catalysts of examples 1 to 5 were activated in a reducing atmosphere of 5-50 vol.-% H₂ in an inert gas (Ar or N₂) at temperatures of 450-850° C. The catalytic NH₃-reforming tests were conducted under a partial pressure of ammonia (p(NH₃)) of 20 bar (see results in Table 1), and 30 bar (see results in Table 2). To the NH₃ feed, a fraction of 5,000 vol.-ppm of H₂O was added. Further, the catalysts were tested at GHSV of 4,000 h⁻¹ and the temperature was varied from 300 to 650° C. The conversion of NH₃ as function of the temperature are shown in FIGS. 1 and 2 and Tables 1 and 2.

TABLE 1
Results for the conversion of ammonia over the Ni-based catalysts
(extrudates) of reference examples 2 and 3 and of example 4.

| | Sample (Ex.) | | | |
|---|---|---|---|---|
| | | 15-Ni + | 15-Ni + | 15-Ni + 0.5 Ru / |
| | 15-Ni | 0.1 Ru | 0.5 Ru | 5 KOH |
| Temp. | (Ref. Ex. 2) | (Ref. Ex. 3) | (Ref. Ex. 3) | (Ex. 4) |
| [° C.] | X(NH3) [%] | X(NH3) [%] | X(NH3) [%] | X(NH3) [%] |
| 300 | 0.10 | 0.06 | 0.10 | 0.40 |
| 350 | 0.32 | 0.43 | 0.46 | 1.96 |
| 400 | 1.93 | 1.77 | 2.89 | 8.89 |
| 450 | 7.12 | 6.18 | 10.67 | 24.44 |
| 500 | 14.98 | 16.93 | 21.20 | 55.67 |
| 550 | 34.34 | 40.97 | 46.53 | 86.65 |
| 600 | 62.45 | 73.81 | 76.51 | 97.51 |
| 650 | 93.05 | 95.58 | 96.37 | 98.69 |

Thus, as may be taken from the results obtained from the testing of the respective catalysts displayed in Table 1 and FIG. 1, the promotion of the Ni-based catalyst of reference example 2 with relatively small amounts of Ru already leads to noticeable improvements in the ammonia conversion rates, wherein higher conversion may already be obtained at lower temperatures for the catalysts of reference example 3. Quite surprisingly, however, the further addition of K as a promoter in the Ru-promoted Ni-catalyst in example 4 leads to a considerable leap in ammonia conversion at lower temperatures, such that a 50% ammonia conversion rate is already achieved at 490° C. Furthermore, the inventive catalyst according to example 4 displays an ammonia conversion rate corresponding to the equilibrium conversion at around 600° C., whereas the Ni catalyst of reference example 2 only displays a conversion rate of slightly greater that 60% at that temperature, whereas the conversion rate of the Ru-promoted Ni catalysts of reference example 3 do not exceed 77%. Accordingly, it has quite unexpectedly been found that the use of comparatively low amounts of Ru in a Ni-based catalyst promoted with K affords unexpectedly high conversion rates at low temperatures when employed for the decomposition of ammonia, wherein only small amounts of Ru are required for obtaining a highly efficient catalyst.

TABLE 2
Results for the conversion of ammonia over the Ni-based catalysts
(tablets) of reference examples 1 and 3 and of examples 4 and 5.

| | Sample (Ex.) | | | |
|---|---|---|---|---|
| | | 15-Ni + | 15-Ni + 0.5 Ru / | 15-Ni + |
| | 15-Ni | 0.5 Ru | 5 KOH | 5 KOH |
| Temp. | (Ref. Ex. 1) | (Ref. Ex. 3) | (Ex. 4) | (Comp. Ex. 5) |
| [° C.] | X(NH3) [%] | X(NH3) [%] | X(NH3) [%] | X(NH3) [%] |
| 350 | 0.37 | 0.78 | 1.89 | 0.19 |
| 400 | 1.43 | 2.95 | 8.14 | 0.81 |
| 450 | 4.85 | 8.27 | 25.06 | 2.97 |
| 500 | 14.18 | 19.67 | 53.90 | 9.93 |
| 550 | 33.27 | 41.68 | 81.10 | 22.85 |
| 600 | 64.57 | 73.96 | 95.47 | 45.64 |
| 650 | 90.88 | 94.37 | 98.16 | 74.08 |

As may be taken from the results obtained from the testing of the respective catalysts displayed in Table 2 and FIG. 2, on the other hand, corresponding results are obtained for the tableted Ni-catalyst from reference example 1 compared to the extruded Ni-catalyst from reference example 2 as shown in Table 1 and FIG. 1. Same applies accordingly for the tableted catalyst of reference example 3 loaded with 0.5 wt.-% Ru and for the inventive tableted catalyst of example 4 loaded with 0.5 wt.-% Ru and 3.5 wt. % K. In Table 2 and FIG. 2, the results obtained using a tableted Ni-catalyst which has only been loaded with 3.5 wt.-% of K according to comparative example 5 is shown for comparison. As may be taken from the results, the Ni-catalyst of the comparative example which only contains K and does not additionally contain any Ru shows a performance which is considerably inferior to the Ni-catalyst of reference example 1. Accordingly, it has quite unexpectedly been found that there is a very strong synergetic effect may be achieved by adding small amounts of Ru to a catalyst containing Ni and K, wherein said effect is magnitudes greater than the improvement observed when adding the same small amount of Ru to a catalyst only containing Ni.

Therefore, it has quite surprisingly been found that the catalyst of the present invention shows a very strong synergetic effect between the Ni, Ru, and K components which would by no means have been expected when considering the results obtained for the catalyst containing only Ni, the catalyst containing only Ni and Ru, and the catalyst containing only Ni and K. This result is all the more surprising in view of the fact that the performance of the catalyst containing only Ni and K is significantly worse than the performance of the catalyst containing only Ni.

### CITED PRIOR ART

I. Lucentini et al., Ind. Eng. Chem. Res. 2021, 60, 18560-18611
T. Le et al., Korean J. Chem. Eng., 2021, 38(6), 1087-1103
Bell et al., Top Catal., 2016, 59,1438-1457
X.-K. Li et al., Journal of Catalysis, 2005, 236, 181-189

1.-15. (canceled)

16. A catalyst comprising Ni, Ru, and a promoter metal M1, wherein the catalyst displays an Ru:Ni weight ratio in the range of from 0.0001:1 to 0.5:1, wherein the promoter metal M1 is selected from the group consisting of Li, K, Na, Cs, Mg, Ca, Sr, and Ba, including mixtures of two or more thereof, wherein the catalyst further comprises one or more support materials onto which Ni, Ru, and the promoter metal M1 are respectively supported,
wherein the catalyst displays an Ni:M1 atomic ratio in the range of from 1.5:1 to 10:1,
wherein the catalyst comprises Ni in an amount in the range of from 10 to 25 wt.-% calculated as the element and based on 100 wt.-% of the catalyst,
wherein the catalyst comprises Ru in an amount in the range of from 0.3 to 0.8 wt.-% calculated as the element and based on 100 wt.-% of the catalyst, and
wherein the catalyst comprises the promoter metal M1 in an amount in the range of from 0.5 to 10 wt.-% calculated as the element and based on 100 wt.-% of the catalyst.

17. The catalyst of claim 16, wherein the catalyst displays an Ni:M1 atomic ratio in the range of from 2:1 to 6:1.

18. The catalyst of claim 16, the catalyst comprises Ni in an amount in the range of from 12 to 18 wt.-% calculated as the element and based on 100 wt.-% of the catalyst.

19. The catalyst of claim 16, the catalyst comprises Ru in an amount in the range of from 0.4 to 0.6 wt.-% calculated as the element and based on 100 wt.-% of the catalyst.

20. The catalyst of claim 16, the catalyst comprises the promoter metal M1 in an amount in the range of from 1 to 8 wt.-% calculated as the element and based on 100 wt.-% of the catalyst.

21. The catalyst of claim 16, wherein the catalyst comprises the one or more promoter metal M1 as a hydroxide, as a hydrogencarbonate, and/or as a carbonate.

22. The catalyst of claim 16, wherein the catalyst is in the form of a molding, in the form of extrudates, and/or in powder form.

23. A method for the preparation of a catalyst according to claim 16, the method comprising:
(1) preparing a mixture comprising one or more sources of Ni, one or more support materials and/or one or more precursors thereof, and water;
(2) shaping of the mixture obtained in (1);
(3) calcination of the shaped body obtained in (2);
(4) impregnation of the calcined shaped body obtained in (3) with an aqueous solution of one or more Ru salts;
(5) calcination of the impregnated shaped body obtained in (4);
(6) impregnation of the calcined shaped body obtained in (5) with an aqueous solution of one or more salts of a promoter metal M1, wherein the promoter metal M1 is selected from the group consisting of Li, K, Na, Cs, Mg, Ca, Sr, and Ba, including mixtures of two or more thereof, and
(7) calcination of the impregnated shaped body obtained in (6).

24. A process for the reforming of ammonia, wherein the process comprises:
(i) providing a reactor containing a catalyst according to claim 16;
(ii) preparing a feed gas stream comprising NH₃;
(iii) feeding the feed gas stream prepared in (ii) into the reactor provided in (i) and contacting the feed gas stream with the catalyst; and
(iv) removing an effluent gas stream from the reactor, the effluent gas stream comprising H₂ and N₂.

25. The process of claim 24, wherein contacting in (iii) is performed at a temperature in the range of from 300 to 1,100° C.

26. The process of claim 24, wherein the feed gas stream prepared in (ii) comprises from 100 to 50,000 ppm of H₂O.

27. The process of claim 24, wherein the total amount of NH₃, N₂, and H₂ comprised in the feed gas stream prepared in (ii) is in the range from 90 to 100 wt.-%.

28. The process of claim 24, wherein the feed stream is fed into the reactor at a gas hourly space velocity in the range of from 500 to 40,000 h⁻¹.

29. The process of claim 24, wherein after (i) and prior to (iii) the catalyst contained in the reactor provided in (i) is reduced in an atmosphere comprising hydrogen and/or NH₃.

30. Use of a catalyst according to claim 16 in the reforming of NH₃ to N₂ and H₂.
